(19) United States
(12) Patent Application Publication
(10) Pub. No.: US 2025/0165824 A1
(43) Pub. Date: May 22, 2025

(54) QUANTUM-COMPUTING-ENHANCED SYSTEMS AND METHODS FOR ENTITY ALLOCATION

(71) Applicant: PwC Product Sales LLC, New York, NY (US)

(72) Inventors: Saurabh Sunil CHOUDHARY, Bhandara (IN); Arit Kumar BISHWAS, San Francisco, CA (US); Bibhash Chandra MITRA, Burdwan (IN)

(73) Assignee: PwC Product Sales LLC, New York, NY (US)

(21) Appl. No.: 18/511,630

(22) Filed: Nov. 16, 2023

(51) Int. Cl. G06N 10/20

(52) U.S. Cl. CPC G06N 10/20

(57) ABSTRACT

A method for assigning entities to assignees may involve receiving information indicating a plurality of entities and a plurality of assignees. Each entity of the plurality of entities may have an associated valuation. Next, based on the received information, values of one or more constraints associated with an objective function that defines variations in a total valuation of entities assigned to each assignee may be set. A quantum computing system may then be used to determine an entity assignment distribution that assigns one or more entities of the plurality of entities to each assignee of the plurality of assignees.

### FIELD

The present disclosure relates generally to quantum computing techniques for allocating entities to assignees, for example for allocating projects to workers.

### BACKGROUND

Optimization problems that involve determining how a set of entities should be distributed among a set of assignees are found in a variety of fields. For example, a company may wish to determine how a set of projects that the company has been tasked with completing should be allocated among a group of employees in order to ensure that the projects are completed in a timely manner. Similarly, a government may want to determine how a set of resources should be distributed among a group of resource consumers in order to ensure that equitable resource access is being provided.

### SUMMARY

While optimization problems involving allocating entities among assignees are prevalent in numerous fields, solving such problems is computationally challenging. Classical computers can take over a minute to determine how relatively small numbers of entities (e.g., around 100) should be distributed among relatively small numbers of assignees (e.g., around 20) in a way that satisfies all necessary constraints. As the scale of a problem grows—for instance, as the number of entities or the number of assignees increases, or as the constraints become more complex—the run time required for a classical computer to generate a solution may quickly and significantly rise. The computational challenges associated with generating a solution may, in many cases, limit the quality of said solution; identifying other, more optimal solutions to a problem is often impractical, even when the existence of more optimal solutions is suspected or known.

Accordingly, disclosed herein are systems and methods for utilizing quantum computing to distribute entities among a group of assignees. Quantum computers are capable of solving computationally complex (e.g., NP-hard) problems at higher speeds than classical computers. By harnessing the advantages in computing ability provided by quantum computers, the techniques provided herein enable entity assignment distributions to be generated with higher efficiency than that which is possible with exclusively classical computational processes.

The described systems and methods may produce entity assignment distributions by configuring a quantum computing system (for example, a quantum annealer) to extremize an objective function that captures the relative total valuation of entities assigned to each assignee. The objective function may be configured automatically by a classical computing system into which information associated with the entities and the assignees has been input. After an entity assignment distribution is produced by the quantum computing system, information associated with the distribution may be returned from the quantum computing system to the classical computing system, which may then execute a set of automated actions according to the distribution.

A method for generating an entity assignment distribution may involve receiving information indicating a plurality of entities, each of which may have an associated valuation, and a plurality of assignees. The method may further comprise setting, based on the received information, values of one or more constraints associated with an objective function that defines variations in a total valuation of entities assigned to each assignee. A quantum computing system may then be used to determine, based on the objective function and the values of the one or more constraints, an entity assignment distribution that assigns one or more entities of the plurality of entities to each assignee of the plurality of assignees. The quantum computing system can be a quantum annealer, and determining the entity assignment distribution can involve solving a constrained quadratic method (QCM) problem or minimizing an output value of the objective function. The entity assignment information may be output to each of the plurality of assignees according to the determined entity assignment distribution.

The one or more constraints associated with the objective function may include constraints indicating a maximum number of assignees to which each entity should be assigned. In some embodiments, the maximum number of assignees to which each entity should be assigned is one.

In some embodiments, the plurality of entities is a plurality of projects, and the plurality of assignees is a plurality of members of a group tasked with completing the plurality of projects. The valuation associated with each project may be an amount of time required to complete the project.

The objective function may include, for each assignee of the plurality of assignees, an associated assignee term representing the total valuation of entities assigned to the assignee. The assignee term associated with the j-th assignee of the plurality of assignees may be Wⱼ=Σᵢdᵢxᵢⱼ, wherein j represents the j-th assignee of the plurality of assignees, i represents the i-th entity of the plurality of entities, dᵢ represents the valuation of the i-th entity of the plurality of entities, xᵢⱼ is a binary variable indicating whether the i-th entity of the plurality of entities is assigned to the j-th assignee of the plurality of assignees and Wⱼ represents the total valuation of entities assigned to the j-th assignee of the plurality of assignees. xᵢⱼ=1 may indicate that the i-th entity of the plurality of entities is assigned to the j-th assignee of the plurality of assignees, while xᵢⱼ=0 may indicate that the i-th entity of the plurality of entities is not assigned to the j-th assignee of the plurality of assignees. The objective function may be f_{obj}+=(Wₖ-Wₘ)², wherein the value of f_{obj} is updated for every k and for every m, wherein k and m are in the set (0, T], where T is a total number of assignees in the plurality of assignees, Wₖ represents the total valuation of entities assigned to the k-th assignee of the plurality of assignees, and Wₘ represents the total valuation of entities assigned to the m-th assignee of the plurality of assignees.

A system for generating an entity assignment distribution may include a classical computing system and a quantum computing system. The system may be configured to receive, using the classical computing system, information indicating a plurality of entities, each of which has an associated valuation, and a plurality of assignees. The classical computing system may be used to set, based on the received information, values of one or more constraints associated with an objective function that defines variations in a total valuation of the entities assigned to each assignee. The quantum computing system may the determine, based on the objective function and the values of the one or more constraints, an entity assignment distribution that assigns one or more entities of the plurality of entities to each assignee of the plurality of assignees. The quantum computing system may be a quantum annealer and may determine the entity assignment distribution by solving a constrained quadratic method (QCM) problem or by minimizing an output value of the objective function. The system may be further configured to output, using the classical computing system, entity assignment information to each of the plurality of assignees according to the determined entity assignment distribution.

The one or more constraints associated with the objective function may include constraints indicating a maximum number of assignees to which each entity should be assigned. In some embodiments, the maximum number of assignees to which each entity should be assigned is one.

In some embodiments, the plurality of entities is a plurality of projects, and the plurality of assignees is a plurality of members of a group tasked with completing the plurality of projects. The valuation associated with each project may be an amount of time required to complete the project.

### BREIF DESCRIPTION OF THE FIGURES

The following figures show various systems and methods for allocating entities to assignees using quantum computing, according to some embodiments. The systems and methods shown in the figures may have any one or more of the characteristics described herein.

FIG. 1A shows a block diagram of an entity allocation system, according to some embodiments.

FIG. 1B shows a block diagram of a classical computing system, according to some embodiments.

FIG. 1C shows a block diagram of a quantum computing system, according to some embodiments.

FIG. 1D shows a visualization of an example entity assignment distribution generated by an entity allocation system.

FIG. 2 shows a method for allocating entities, according to some embodiments.

FIG. 3A shows a graphical representation of a method for determining an entity assignment distribution using quantum annealing, according to some embodiments.

FIG. 3B shows a method for determining an entity assignment distribution using quantum annealing, according to some embodiments.

FIG. 4A shows data comparing total amounts of time required by members of a group to complete sets of projects when the projects are allocated to group members according to the methods described herein and when the projects are allocated to group members using solely classical techniques.

FIG. 4B shows data comparing total amounts of time required by a classical computing system to allocate projects to group members and total amounts of time required by the systems described herein to allocate projects to group members.

### DETAILED DESCRIPTION

As discussed, optimization problems that involve determining how a set of entities should be distributed among a set of assignees are widespread. Regardless of context, problems of this type may have the following structure: a set of entities, each of which has an associated valuation (for example, an associated cost, an associated duration, an associated amount, etc.) must be allocated to a set of assignees (e.g., users or consumers of the entities) such that all constraints are met and such that the total valuation of entities assigned to each assignee is approximately the same.

Solving problems of this form is computationally challenging. Classical computing algorithms may require several minutes to generate a solution to a problem that satisfies the problem's constraints. The provided systems and methods address these challenges by harnessing the computational capabilities of quantum computing systems. Quantum computers can provide fast and accurate solutions to computationally complex (e.g., NP-hard) optimization problems such as constrained quadratic model (CQM) problems and quadratic unconstrained binary optimization (QUBO) problems. The advantages in computing ability provided by quantum computers may allow high quality entity assignment distributions to be efficiently generated, even for large-scale problems.

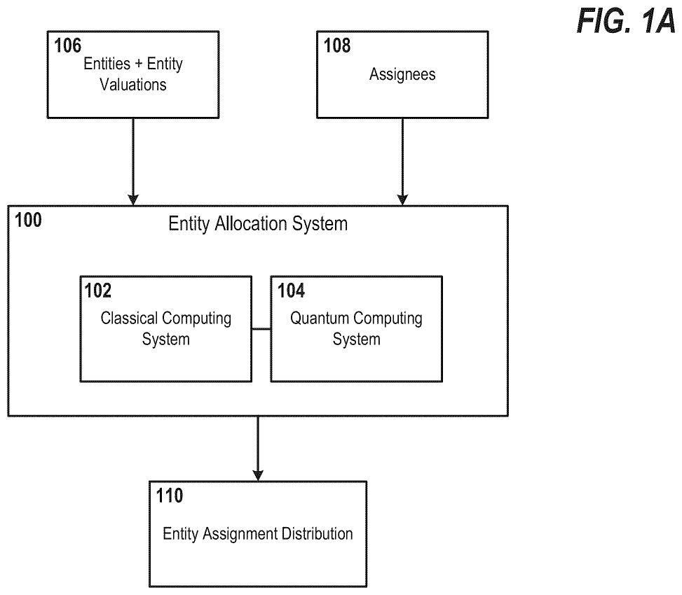

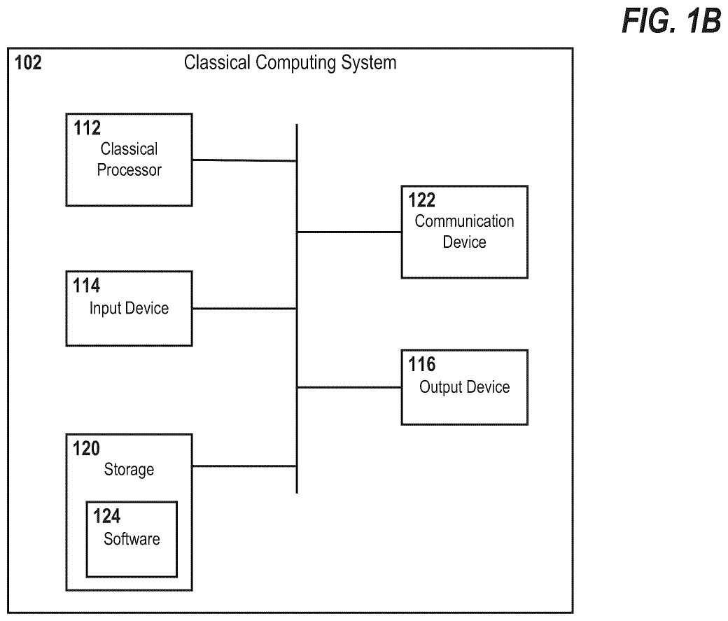

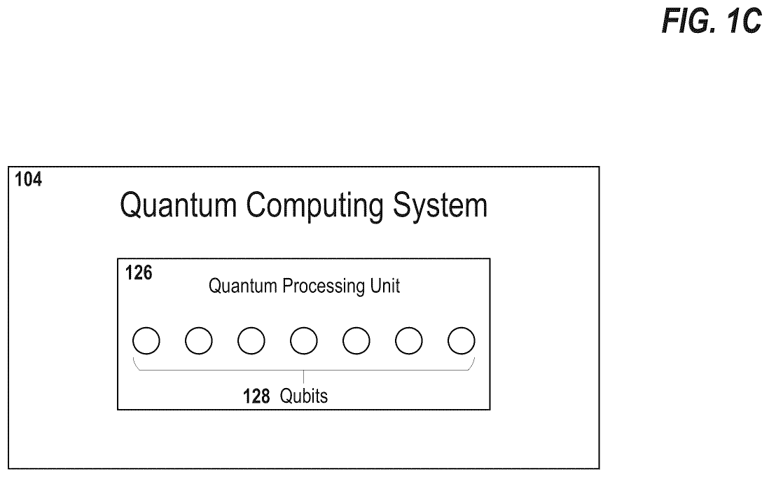

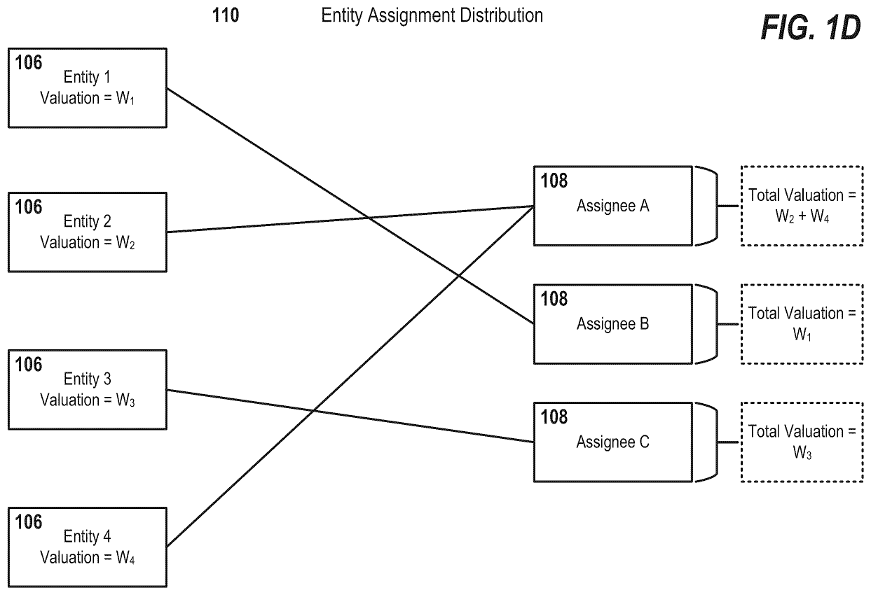

FIG. 1A depicts a block diagram of an exemplary entity allocation system 100. As shown, system 100 may include a classical computing system 102 and a quantum computing system 104. System 100 may be configured to assign a plurality of entities 106 to a plurality of assignees 108 by using classical computing system 102 and quantum computing system 104 to generate an entity assignment distribution 110 (e.g., a data structure representing an entity assignment distribution) that equalizes (or approximately equalizes, e.g., by minimizing the differences between) the total valuation of the entities assigned to each assignee 108.

Classical computing system 102 can be any suitable type of microprocessor-based device, such as a personal computer, workstation, server, or handheld computing device (portable electronic device) such as a phone or tablet, or dedicated device. As shown in FIG. 1B, classical computing system 102 may include one or more classical (binary) processors 112, an input device 114, an output device 116, storage 120, and a communication device 122.

Input device 114 and output device 116 can be connectable or integrated with system 102. Input device 114 may be any suitable device that provides input, such as a touch screen, keyboard or keypad, mouse, or voice-recognition device. Likewise, output device 116 can be any suitable device that provides output, such as a display, touch screen, haptics device, or speaker.

Storage 120 can be any suitable device that provides (classical) storage, such as an electrical, magnetic, or optical memory, including a RAM, cache, hard drive, removable storage disk, or other non-transitory computer readable medium. Communication device 122 can include any suitable device capable of transmitting and receiving signals over a network, such as a network interface chip or device. The components of classical computing system 102 can be connected in any suitable manner, such as via a physical bus or via a wireless network.

Processor(s) 112 may be or comprise any suitable classical processor or combination of classical processors, including any of, or any combination of, a central processing unit (CPU), a field programmable gate array (FPGA), and an application-specific integrated circuit (ASIC). Software 124, which can be stored in storage 120 and executed by processor(s) 112, can include, for example, the programming that embodies the functionality of the present disclosure. Software 124 may be stored and/or transported within any non-transitory computer-readable storage medium for use by or in connection with an instruction execution system, apparatus, or device that can fetch instructions associated with the software from the instruction execution system, apparatus, or device and execute the instructions. In the context of this disclosure, a computer-readable storage medium can be any medium, such as storage 120, that can contain or store programming for use by or in connection with an instruction execution system, apparatus, or device.

Software 124 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Classical computing system 102 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Classical computing system 102 can implement any operating system suitable for operating on the network. Software 124 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

Classical computing system 102 may be configured to receive information associated with the plurality of entities 106. The information associated with the plurality of entities 106 may include information indicating a total number of entities as well as information indicating the valuation of each of the plurality of entities 106. In some embodiments, the information associated with the plurality of entities 106 also includes descriptions of, or other metadata associated with, one or more entities of the plurality of entities. The information associated with the plurality of entities 106 may be input to classical computing system 102 by one or more users (e.g., via a user interface) or may be automatically downloaded from one or more information sources (e.g., one or more databases storing entity information). In some embodiments, information associated with one or more of the plurality of entities may be programmatically determined by system 102 and/or by an associated computing system. For example, the valuation of one or more entities may be automatically determined by the system based on one or more predefined rules and/or algorithms.

The plurality of entities 106 may include any number of entities. In some embodiments, the plurality of entities 106 includes at least 2, at least 10, at least 20, at least 30, at least 40, at least 50, at least 100, at least 200, at least 300, at least 400, or at least 500 entities. In some embodiments, the plurality of entities 106 includes 2-10, 2-50, 2-100, 2-500, or 2-1000 entities.

The types of entities that constitute the plurality of entities 106 may vary based on problem context. In some embodiments, the entities are projects or tasks that require completion. For example, the entities may be projects that a group (e.g., an organization, company, etc.) has been tasked with completing. In other embodiments, the entities are computational tasks (e.g., steps in a computational process) that require execution.

The valuation of an entity may be a cost (e.g., a monetary cost or a duration) or a benefit (e.g., an amount of a resource) imparted upon assignees to which the entity is assigned. If, for example, the entities are projects that require completion, the valuation of a given entity may be an amount of time needed for an assignee (or a group of assignees) to complete the project. Similarly, if the entities are resources to be consumed, then the valuation of an entity may be an amount of the resource that is received by the assignee (or a group of assignees) to which the entity is assigned.

Information associated with the plurality of assignees 108 may be received by classical computing system 102, as well. The information associated with the plurality of assignees 108 may indicate a total number of available assignees. The plurality of assignees 108 may, in various embodiments, comprise at least 2, at least 3, at least 4, at least 5, at least 10, at least 15, at least 20, at least 25, at least 30, at least 35, at least 50, at least 100, at least 500, or at least 1000 assignees. The information associated with the plurality of assignees 108 may be input to classical computing system 102 by one or more users (e.g., via a user interface) or may be automatically downloaded from one or more information sources (e.g., one or more databases storing assignee information). In some embodiments, information associated with one or more of the plurality of assignees may be programmatically determined by system 102 and/or by an associated computing system. For example, the valuation of one or more entities may be automatically determined by the system based on one or more predefined rules and/or algorithms.

Like the types of entities that constitute the plurality of entities 106, the types of assignees that constitute the plurality of assignees 108 may vary based on problem context. In some embodiments, the assignees are members of a group (e.g., employees) who are capable of (e.g., possess the necessary skillset, resources, capacity, energy, etc.) completing a set of projects. In other embodiments, the assignees are computational resources (e.g., computer hardware or software) that are capable of executing a computational task.

Classical computing system 102 may be communicatively coupled to quantum computing system 104. Quantum computing system 104 may be any suitable quantum-processor-based device. In other words, as illustrated in FIG. 1C, quantum computing system 104 may be any device comprising a quantum processing unit (QPU) 126 configured to perform computational operations by encoding information in and manipulating the quantum states of one or more qubits 128. In some embodiments, quantum computing system 104 may be or may comprise a specific class of quantum computer such as, e.g., a quantum annealer.

Each qubit 128 may be a two-state quantum mechanical system. Possible implementations of qubits 128 can include, in non-limiting examples, electrons (e.g., electron spin qubits), photons (e.g., polarization encoding or time bin encoding qubits), atomic nuclei (e.g., nuclear spin encoded qubits), quantum dots, Josephson junctions (e.g., flux qubits), and solid-state defects (e.g., nitrogen vacancy centers in diamond).

To facilitate the encoding and manipulation of information, quantum computing system 104 may include devices such as lasers, microwave radiation sources, voltage sources, current sources, digital-to-analog converters, application specific integrated circuits (ASICs), and field programmable gate arrays (FPGAs). Additionally, quantum computing system 104 may include any environmental control components necessary to stabilize qubits 128. For example, quantum computing system 104 may include apparatuses configured to control the temperature of qubits 128. Quantum computing system 104 can also include one or more classical computing devices (e.g., CPUs or GPUs) configured to interface with QPU 126 to (for example) compile instructions for a given quantum algorithm to be executed by the quantum computing system 104 or process quantum-state measurements after the quantum algorithm is executed. In some embodiments, quantum computing system 104 shares one or more components with classical computing system 102.

FIG. 1D provides a graphical representation of an exemplary entity assignment distribution 110. In this example, a set of four entities (entity 1, entity 2, entity 3, and entity 4) is distributed among a set of three assignees (assignee A, assignee B, and assignee C). Each of the four entities has an associated valuation. Specifically, entity 1 has a valuation W₁, entity 2 has a valuation W₂, entity 3 has a valuation W₃, and entity 4 has a valuation W₄. According to entity assignment distribution 110, entity 1 is assigned to assignee B, entities 2 and 4 are assigned to assignee A, and entity 3 is assigned to assignee C. The total valuation of entities assigned to entity A is, therefore, the sum of the valuation of entity 2 and the valuation of entity 4 (W₂+W₄). The total valuation of entities assigned to entity B is the valuation of entity 1 (W₁). The total valuation of entities assigned to entity C is the valuation of entity 3 (W₃).

Entity assignment distribution 110 may assign entities to assignees such that the total valuation of entities assigned to any given assignee is approximately equal to the total valuations of entities assigned to every other assignee. Thus, in the example shown in FIG. 1D, the total valuation of entities assigned to entity A may be approximately equal to the total valuation of entities assigned to entity B which may, in turn, be approximately equal to the total valuation of entities assigned to entity C. That is,

$${W}_{2} + {W}_{4} \approx {W}_{1} \approx {W}_{3}$$

In various embodiments, the total valuation of entities assigned to a first assignee may be approximately equal to the total valuation of entities assigned to a second assignee if the total valuation of entities assigned to the first assignee is within 1%, 2%, 3%, 4%, 5%, 10%, 15%, 20%, or 25% of the total valuation of entities assigned to the second assignee.

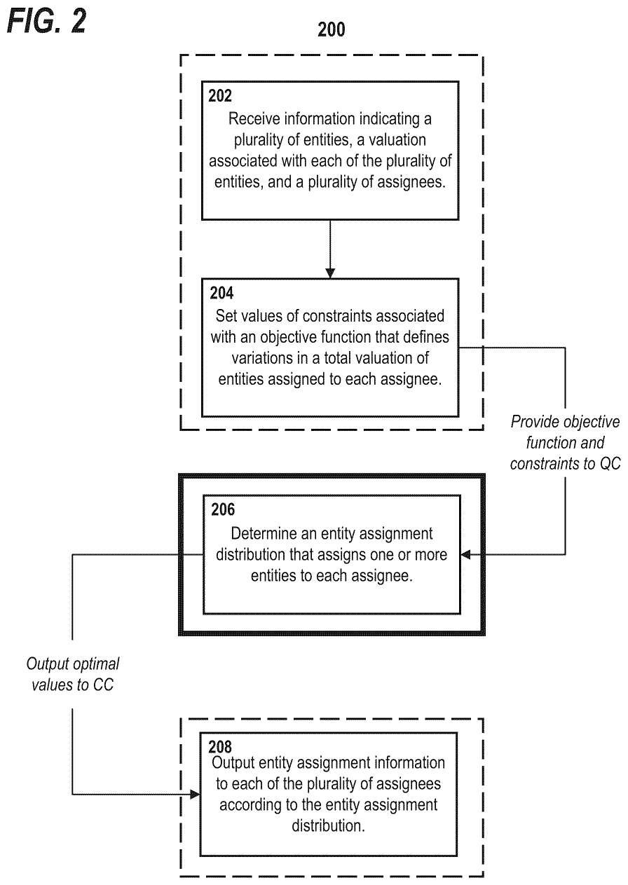

An exemplary method 200 for allocating entities to assignees is provided in FIG. 2. Method 200 may be executed by a system (e.g., system 100 shown in FIG. 1A) comprising a classical computing system (e.g., classical computing system 102 shown in FIGS. 1A-1B) and a quantum computing system (e.g., quantum computing system 104 shown in FIGS. 1A and 1C). In some embodiments, method 200 can be performed on a regular, pre-scheduled basis (e.g., once per day, once per week, once per month, etc.). Method 200 may also be initiated by the detection or prediction of certain events (e.g., a change in a number of entities to be allocated or a change in a number of assignees to which entities can be assigned) or by request from a user.

As shown, method 200 may begin with the receipt, by the classical computing system, of information pertaining to a plurality of entities to be allocated and a plurality of assignees to which entities can be assigned (step 202). In some embodiments, the information pertaining to the plurality of entities and the plurality of assignees includes a total number of entities, a valuation associated with each entity, and a total number of assignees. The classical computing system may receive this information directly from a user (e.g., via a user interface), automatically from various information sources (e.g., from databases storing information about the plurality of entities or the plurality of assignees), or from combinations thereof.

After the information pertaining to the plurality of entities to be allocated and the plurality of assignees to which entities can be assigned is received by the classical computing system, the values of one or more constraints associated with an objective function that defines variations in a total valuation of entities assigned to each assignee may be set (step 204). Since the total valuation of entities assigned to each assignee may depend upon the total number of entities assigned to each assignee, the value of the objective function may depend on a total number of entities assigned to each assignee. That is, the value of the objective function may depend on how the entities are distributed among the assignees, and thus may depend on the entity assignment distribution. The objective function may be configured such that the entity assignment distribution that extremizes (e.g., maximizes or minimizes) the objective function is a distribution in which the total valuation of entities assigned to any given assignee is (approximately) the same as the total valuation of entities assigned to every other assignee. The objective function may be stored in the memory of the classical computing system.

The objective function may comprise, for each of the plurality of assignees, an associated assignee term that represents the total valuation of entities assigned to the assignee. An example such assignee term is provided in Equation 1,

$${W}_{j} = {\sum }_{i} {d}_{i} {x}_{ij} \qquad ( 1 )$$

wherein j may represent the j-th assignee of the plurality of assignees, i may represent the i-th entity of the plurality of entities, dᵢ may represent the valuation of the i-th entity of the plurality of entities, xᵢⱼ may be a binary variable indicating whether the i-th entity of the plurality of entities is assigned to the j-th assignee of the plurality of assignees, and Wⱼ may represent the total valuation of entities assigned to the j-th assignee of the plurality of assignees. In some embodiments,

$${x}_{ij} = \{ \begin{matrix}1 , if the i - th entity is assigned to the j - th assignee \\ 0 , if the i - th entity is not assigned to the j - th assignee\end{matrix} \qquad ( 2 )$$

The objective function may, in this case, have the form provided in Equation 3:

$${f}_{obj} + = {( {W}_{k} - {W}_{m} )}^{2} \qquad ( 3 )$$

Here, k and m may be in the set of integers in the range (0, T], where T is the total number of assignees in the plurality of assignees, Wₖ may represent the total valuation of entities assigned to the k-th assignee of the plurality of assignees (given by Equation 1), and Wₘ may represent the total valuation of entities assigned to the m-th assignee of the plurality of assignees (given by Equation 1). The initial value of f_{obj} (which may be set by a user) may be zero. For a given entity assignment distribution, the value of f_{obj} may be iteratively updated by adding to the current value of f_{obj} the value of the squared difference (Wₖ-Wₘ)² between Wₖ and Wₘ for each k and for each m in the set of integers in the range (0, T].

The constraints associated with the objective function can include constraints on the total number of assignees to which a given entity can be assigned, constraints on a total number of entities that can be assigned to a given assignee, constraints on a total valuation of entities that can be assigned to each assignee, or combinations thereof. In some embodiments, the classical computing system updates the values of one or more constraints automatically based on the information received in step 202. In other embodiments, a user manually updates the values of one or more constraints, for example by inputting information associated with the one or more constraints into the classical computing system. An example constraint that may be associated with the objective function given by Equation 3 may be:

$${\sum }_{j} {x}_{ij} = α \qquad ( 4 )$$

Equation 4 constrains the total number of assignees to which the i-th entity can be assigned to a number α. α may be a non-negative integer (i.e., an integer greater than or equal to zero). If, for instance, α=1, then the i-th entity may only be assigned to at most one assignee. If, instead, α=5, then the i-th entity may be split between five entities. In some embodiments, the value of α varies for each entity. In other embodiments, the value of α is the same for every entity.

After the values of the constraints associated with the objective function are updated by the classical computing system, the objective function, along with the constraints, may be provided to the quantum computing system. Using the quantum computing system, an entity assignment distribution may be determined (step 206). The quantum computing system may be configured to determine the entity assignment distribution by extremizing (e.g., minimizing or maximizing) the objective function in view of the associated constraints. In some embodiments, the problem of extremizing the objective function is in the NP complexity class and thus may be represented as a constrained quadratic model (CQM) problem or a quadratic unconstrained binary optimization problem (QUBO). The forms of these problems are indicated in Table 1.

TABLE 1
CQM and QUBO problems

| Problem | Objective Function | Constraints |
|---|---|---|
| CQM | ${\sum }_{i} {a}_{i} {x}_{i} + {\sum }_{i \leq j} {b}_{ij} {x}_{i} {x}_{j} + c$ | xᵢ is a binary, integer, or real-valued variable; aᵢ, bᵢⱼ, and c are real numbers; |
| | | m = 1, . . . , M, where M is the total number of |
| | | constraints, and |
| | | ${\sum }_{i} {a}_{i}^{( m )} {x}_{i} + {\sum }_{i \leq j} {b}_{ij}^{( m )} {x}_{i} {x}_{j} + {c}^{( m )} ∘ 0$ |
| | | where ∘ ∈ {≥, ≤, =}. |
| QUBO | ${\sum }_{i \leq j} {x}_{i} {Q}_{i , j} {x}_{j}$ | Q is an upper-diagonal matrix; and xᵢ is a binary variable. |

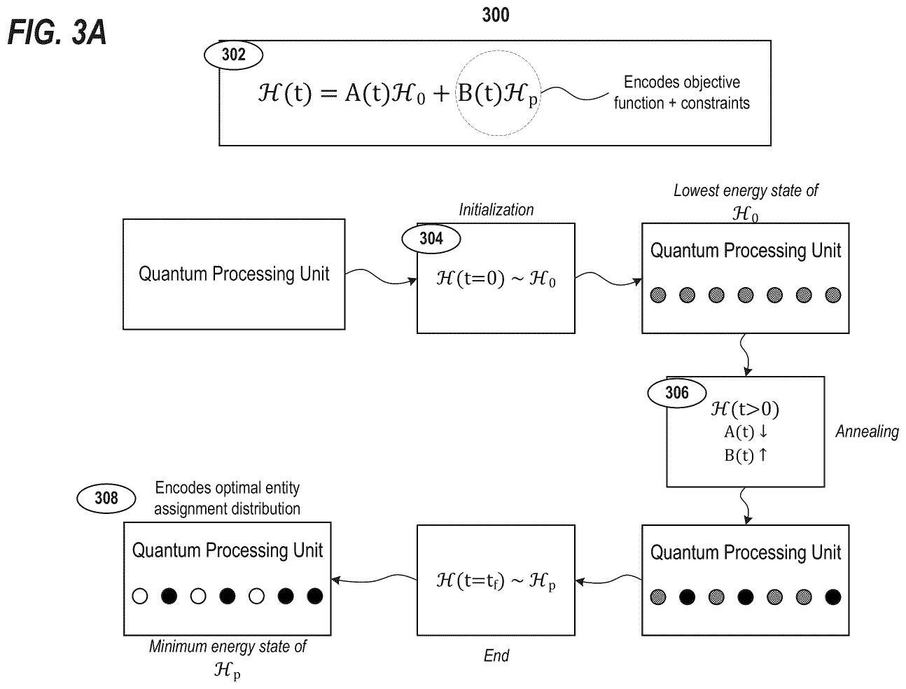

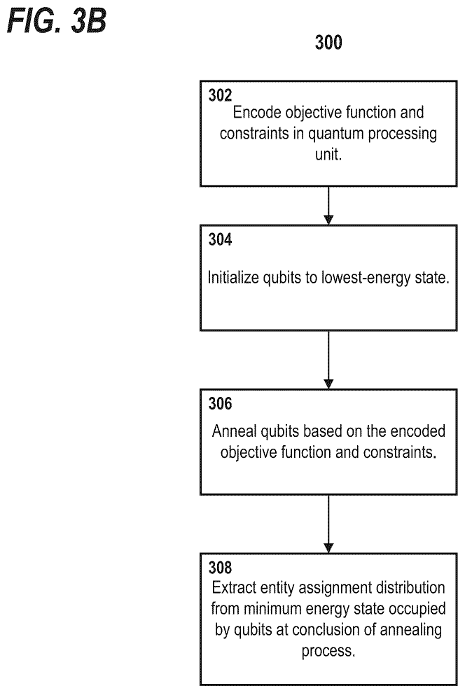

To extremize the objective function, the quantum computing system may execute a quantum optimization process such as quantum annealing. A visual representation of an exemplary quantum annealing process 300 is depicted in FIG. 3A and a corresponding flowchart is provided in FIG. 3B.

To begin the annealing process, the objective function and the associated constraints may be encoded as a time-dependent term ( [symbol] Hₚ, sometimes referred to as the “final Hamiltonian” or the “problem Hamiltonian”) in a Hamiltonian operator ( [symbol] (t)) for qubits in the quantum computing system (step 302). The lowest energy state of this “final Hamiltonian” may correspond to the extremized value of the objective function. Encoding the objective function and the associated constraints in the Hamiltonian may require mapping the logical representations of the function and the constraints onto the physical qubit topology of the quantum computer, e.g., using minor-embedding. This mapping process may be performed manually by a user (e.g., via a user interface that enables the user to interact directly with the quantum computing system) or automatically by a classical computing system configured to interface directly with the quantum computer (e.g., as done by D-Wave's LeapHybridSampler solver). At this stage, annealing parameters such as the total annealing time may also be set, either by a user or automatically.

In addition to the “final Hamiltonian” term, the Hamiltonian operator may include an “initial Hamiltonian” (also known as a “tunnelling Hamiltonian” or “driving Hamiltonian”) term ( [symbol] ₀). As previously noted, each qubit in the quantum computer may be a two-state quantum mechanical system; the ground state of the “initial Hamiltonian” may be a superposition of all states of the qubit system.

The functions A(t) and B(t) may be configured to adjust the weights of the initial Hamiltonian and the final Hamiltonian, respectively, as the annealing process progresses. In other words, A(t) and B(t) may be configured such that, as the annealing process progresses (e.g., as the annealing time parameter t increases from a start time of t=0), the influence of the initial Hamiltonian on the qubits grows weaker and the influence of the final Hamiltonian on the qubits grows stronger, thereby causing the states of qubits to evolve toward the lowest energy state of the final Hamiltonian. In other words, at the start of the annealing process (t˜0), A(t)>>B(t) and, as a result, [symbol] (t)˜ [symbol] ₀.

After the objective function and the associated constraints are encoded in the final Hamiltonian, the qubit system may be initialized to the lowest energy state of [symbol] ₀ (step 304). As the annealing process progresses and the time parameter increases (t>0), the magnitude of A(t) relative to the magnitude of B(t) may decrease, reducing the influence of the initial Hamiltonian and increasing the influence of the final Hamiltonian on the qubits (step 306). The quantum computing system may be configured to execute this process slowly and to minimize interference by energy sources external to the quantum computing system (e.g., to execute the process as close to adiabatically as possible). By the end of the annealing process (t˜t_{f}, where t_{f} is the total annealing time), A(t)<<B(t) and [symbol] (t)˜ [symbol] ₚ. As a result, at the end of the annealing process, the qubits may occupy the lowest energy state of [symbol] ₚ. From this state, information indicating the entity assignment distribution that extremizes the objective function may be extracted (step 308).

Once the entity assignment distribution has been determined by the quantum computing system, entity assignment information may be output to one or more of the plurality of assignees according to the entity assignment distribution. The entity assignment information that is output to a given assignee can indicate a number of entities assigned to said assignee as well as details about each entity assigned to said assignee, including, e.g., the valuation of each entity assigned to said assignee. The entity assignment information may be distributed to the plurality of assignees by the classical computing system. For example, the classical computing system may transmit entity assignment information to a plurality of assignee devices associated with the plurality of assignees. The classical computing system may also store entity assignment information (e.g., in the storage of the classical computing system) or update entity assignment information that was previously generated (e.g., for a previous set of entities or for a previous set of assignees).

In addition to outputting entity assignment information to assignees, the classical computing system may be configured to automatically execute one or more tasks based on the determined entity assignment distribution. For example, if the entities comprise computational tasks to be executed and the assignees comprise computational resources capable of executing said tasks, the classical computing system may be configured to automatically apply or provision the computational resources to the computational tasks according to the determined entity assignment distribution. In some embodiments, automatically provisioning the computational resources to computational tasks according to an entity assignment distribution involves automatically instantiating electronic communicative connections between computational resources and one or more devices associated with the computational tasks to be executed. Automatically provisioning the computational resources to computational tasks according to an entity assignment distribution can also involve automatically allocating computational time (e.g., time on a computing system) to the computational tasks.

### Example 1: Allocating Projects to Members of a Group

As previously noted, the described systems and methods may be used to allocate projects to be completed to members of a group tasked with completing said projects. In particular, the described systems and methods may be used to minimize a total amount of time required by a group to complete a set of projects. The group may be, for example, a group of employees of a company; the projects may be, for example, projects that the company has been hired (e.g., by one or more clients) to complete. Each member of the group may have about the same qualifications—that is, each member of the group may be capable of completing any given project in approximately the same amount of time as any other member of the group. The valuation of a given project may be an expected duration of said project—e.g., a maximum amount of time that a member of the group is expected to need in order to complete said project. Each project may have a different expected duration. The provided systems and methods may minimize total amount of time required by the group to complete the set of projects by assigning projects to group members such that differences in the amount of work that each member of the group is required to complete are minimized.

In this example, the objective function may have the following form:

$${f}_{obj} + = {( {W}_{k} - {W}_{m} )}^{2} \qquad ( 5 )$$

Here, k and m may be in the set (0, T], where T is the total number of members in the group, Wₖ may represent the total duration of projects assigned to the k-th member of the group, and Wₘ may represent the total duration of projects assigned to the m-th number of the group. The total duration of projects assigned to any given member of the group may be given by Equation 6:

$${W}_{j} = {\sum }_{i} {d}_{i} {x}_{ij} \qquad ( 6 )$$

wherein j may represent the j-th member of the group, i may represent the i-th project of the set of projects to be completed, dᵢ may represent the expected duration of the i-th project, xᵢⱼ may be a binary variable indicating whether the i-th project is assigned to the j-th member of the group, and Wⱼ may represent the total amount of work (indicated as the amount of time spend working, e.g., as a total number of hours, days, weeks, months, etc. spent working) assigned to the j-th member of the group. In some embodiments,

$${x}_{ij} = \{ \begin{matrix}1 , if the i - th project is assigned to the j - th group member \\ 0 , if the i - th project is not assigned to the j - th group member\end{matrix} \qquad ( 7 )$$

The number of group members who can work on a given project may be constrained, for example as shown in Equation 8:

$$for every i , {\sum }_{j} {x}_{ij} = 1 \qquad ( 8 )$$

This equation indicates that each project (“for every i”, where i represents the i-th project of the set of projects to be completed) may be assigned to a single member of the group. Variations of this constraint are possible. In some cases, for instance, the projects to be completed may be extensive and, as a result, may ideally be split amongst several members of the group. In other cases, the group members may be inexperienced and may need to divide work for each project in order to ensure the projects are completed in an efficient manner.

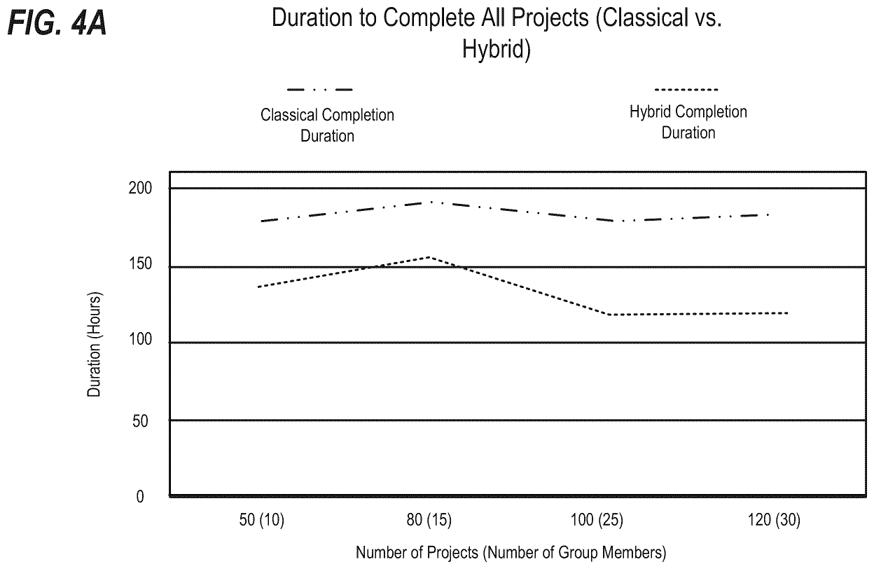

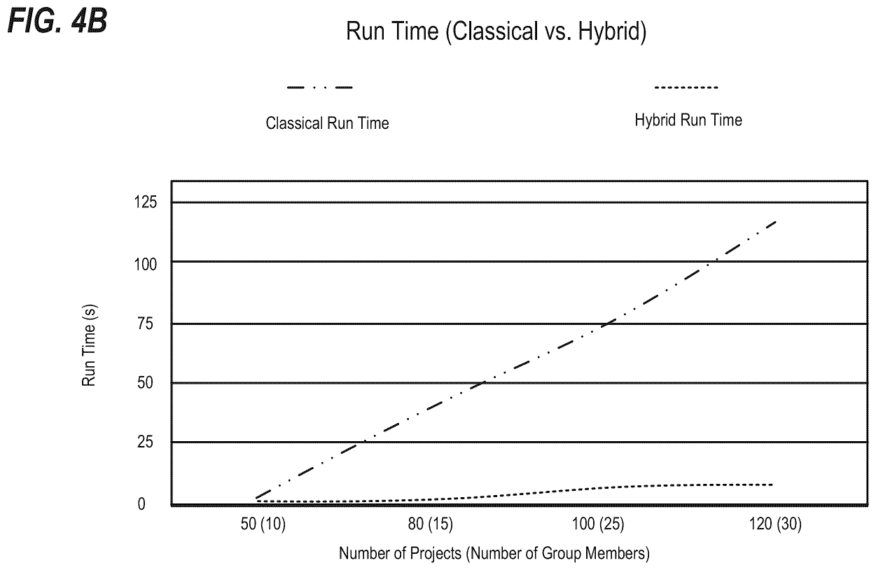

FIG. 4A shows data comparing total amounts of time required by members of a group to complete sets of projects (“duration to complete”) (a) when the projects are allocated to group members according to the methods/using the systems described herein (the classical-quantum “hybrid” techniques) versus (b) when the projects are allocated to group members using solely classical techniques. Specifically, the data compares the durations to complete 50 projects distributed among 10 group members, 80 projects distributed among 15 group members, 100 projects distributed among 25 group members, and 120 projects distributed among 30 group members when the projects are allocated to group members according to a project assignment distribution produced using hybrid techniques and when the projects are allocated to group members according to a project assignment distribution produced using exclusively classical techniques. In all cases, the hybrid techniques described herein generated project assignment distributions that resulted in durations to complete the set of projects. In some cases (for example, for the case of 120 projects distributed among 30 group members), the hybrid techniques provided a project assignment distribution that enabled the projects to be completed in about 100 fewer hours than the completion duration of the projects assigned according to the distribution produced by the classical computing system alone.

In addition to producing high quality solutions, as exemplified by the data shown in FIG. 4A, the provided systems and methods may generate solutions more efficiently than exclusively classical systems. This is indicated in FIG. 4B, which shows data comparing total amounts of time required by a classical computing system to allocate projects to group members and total amounts of time required by the systems described herein to allocate projects to group members. As shown, the run time of the classical system increased from under 25 seconds to approximately 120 seconds as the number of projects increased from 50 to 120 and number of group members increased from 10 to 30. The run time of the hybrid system, however, remained well below 25 seconds even as the number of projects increased from 50 to 120 and number of group members increased from 10 to 30.

### Example 2: Allocating Computational Tasks to Computational Resources

The described systems and methods can also be used to allocate computational tasks to be executed to computational resources capable of executing said tasks. Examples of computational tasks include steps or sequences of instructions in a computational process, computational job, or programming thread, data requests, and information queries. Computational resources can comprise hardware (e.g., specific computational devices), software, computation time, and memory space.

The valuation of a given computational task may be the computational complexity of the task. Each computational task may have a different associated complexity. The provided systems and methods may minimize total amount of time required to execute the set of computational tasks by assigning computational tasks to computational resources such that differences in the amount of work that each computational resource is required to perform are minimized.

In this example, the objective function may quantify the variations in the computational complexity of all of the computational tasks that are assigned to each computational resource. The number or amount of computational resources (e.g., number of threads in a processor, amount of memory, etc.) to which a given computational task can be allocated may be constrained. If the computational tasks are highly complex, the number or amount of computational resources to which a given task can be allocated may be larger. Similarly, if the computational tasks are relatively simple, the number or amount of computational resources to which a given task can be allocated may be smaller.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method comprising:
receiving information indicating:
a plurality of entities, wherein each entity of the plurality of entities has an associated valuation, and
a plurality of assignees;
setting, based on the received information, values of one or more constraints associated with an objective function that defines variations in a total valuation of entities assigned to each assignee; and
determining, using a quantum computing system, based on the objective function and the values of the one or more constraints, an entity assignment distribution that assigns one or more entities of the plurality of entities to each assignee of the plurality of assignees.

2. The method of claim 1, wherein the quantum computing system is a quantum annealer.

3. The method of claim 2, wherein determining the entity assignment distribution comprises solving a constrained quadratic method (QCM) problem.

4. The method of claim 1, wherein determining the entity assignment distribution comprises minimizing an output value of the objective function.

5. The method of claim 1, wherein the one or more constraints associated with the objective function comprise constraints indicating a maximum number of assignees to which each entity should be assigned.

6. The method of claim 5, wherein the maximum number of assignees to which each entity should be assigned is one.

7. The method of claim 1, wherein:
the plurality of entities is a plurality of projects;
the valuation associated with each project is an amount of time required to complete the project; and
the plurality of assignees is a plurality of members of a group tasked with completing the plurality of projects.

8. The method of claim 1, wherein the objective function comprises, for each assignee of the plurality of assignees, an associated assignee term representing the total valuation of entities assigned to the assignee.

9. The method of claim 8, wherein the assignee term associated with the j-th assignee of the plurality of assignees has the following form: Wⱼ=Σᵢdᵢxᵢⱼ,
wherein:
j represents the j-th assignee of the plurality of assignees;
i represents the i-th entity of the plurality of entities;
dᵢ represents the valuation of the i-th entity of the plurality of entities;
xᵢⱼ is a binary variable indicating whether the i-th entity of the plurality of entities is assigned to the j-th assignee of the plurality of assignees; and
Wⱼ represents the total valuation of entities assigned to the j-th assignee of the plurality of assignees.

10. The method of claim 9, wherein:
xᵢⱼ=1 indicates that the i-th entity of the plurality of entities is assigned to the j-th assignee of the plurality of assignees; and
xᵢⱼ=0 indicates that the i-th entity of the plurality of entities is not assigned to the j-th assignee of the plurality of assignees.

11. The method of claim 9, wherein the objective function has the following form: f_{obj}+=(Wₖ-Wₘ)², wherein the value of f_{obj} is updated for every k and for every m, wherein:
k and m are in the set (0, T], where T is a total number of assignees in the plurality of assignees;
Wₖ represents the total valuation of entities assigned to the k-th assignee of the plurality of assignees; and
Wₘ represents the total valuation of entities assigned to the m-th assignee of the plurality of assignees.

12. The method of claim 1, comprising outputting entity assignment information to each of the plurality of assignees according to the determined entity assignment distribution.

13. A system comprising:
a classical computing system; and
a quantum computing system,
wherein the system is configured to:
receive, using the classical computing system, information indicating:
a plurality of entities, wherein each entity of the plurality of entities has an associated valuation, and
a plurality of assignees;
set, using the classical computing system, based on the received information, values of one or more constraints associated with an objective function that defines variations in a total valuation of the entities assigned to each assignee; and
determine, using the quantum computing system, based on the objective function and the values of the one or more constraints, an entity assignment distribution that assigns one or more entities of the plurality of entities to each assignee of the plurality of assignees.

14. The system of claim 13, wherein the quantum computing system is a quantum annealer.

15. The system of claim 14, wherein the quantum computing system determines the entity assignment distribution by solving a constrained quadratic method (QCM) problem.

16. The system of claim 13, wherein the quantum computing system determines the entity assignment distribution by minimizing an output value of the objective function.

17. The system of claim 13, wherein the one or more constraints associated with the objective function comprise constraints indicating a maximum number of assignees to which each entity should be assigned.

18. The system of claim 17, wherein the maximum number of assignees to which each entity should be assigned is one.

19. The system of claim 13, wherein:
the plurality of entities is a plurality of projects;
the valuation associated with each project is an amount of time required to complete the project; and
the plurality of assignees is a plurality of members of a group tasked with completing the plurality of projects.

20. The system of claim 13, wherein the system is configured to output, using the classical computing system, entity assignment information to each of the plurality of assignees according to the determined entity assignment distribution.
